(19) United States
(12) Patent Application Publication
(10) Pub. No.: US 2005/0110736 A1
(43) Pub. Date: May 26, 2005

(54) Display device

(76) Inventor: Yushi Jinno, Gifu-shi (JP)

Correspondence Address: CANTOR COLBURN, LLP, 55 GRIFFIN ROAD SOUTH, BLOOMFIELD, CT, 06002, US

(21) Appl. No.: 10/952,958

(22) Filed: Sep. 29, 2004

(30) Foreign Application Priority Data
Sep. 30, 2003 (JP) 2003-342049

(51) Int. Cl. G09G 3/36; G09G 3/04

(52) U.S. Cl. 345/92

(57) ABSTRACT

Immediately after formation of, for example, power supply lines formed on a same substrate and set to a same potential, defect examination is applied and a repair line is formed connecting deficient defect (disconnection) portion of the power supply line, directly covering the power supply line. The repair line can be formed through a drawing process by scanning with a laser beam within a gas atomospshere of a conductive material such as, for example, tungsten, to connect ends of the disconnection. By repairing the power supply line by directly covering the power supply line, an increase in a line resistance is inhibited and flatness above the repair line is further improved.

### CROSS-REFERENCE TO RELATED APPLICATIONS

The priority Japanese Patent Application Number 2003-342049 upon which this patent application is based is hereby incorporated in its entirety by reference.

### BACKGROUND OF THE INVENTION

1. Field of the Invention

The present invention relates to the repairing of a defective circuit line pattern in a semiconductor device such as a display device.

2. Description of the Related Art

As one example of a semiconductor device, an active matrix display device is well-known in which a thin film transistor (hereinafter simply referred to as “TFT”) for driving a display element is provided for each pixel. Among such active matrix display devices, an active matrix liquid crystal display device (hereinafter simply referred to as “LCD”) in which liquid crystal is used as the display element is currently widely in use for various high resolution display devices, including computer monitors and television screens. In such an active matrix liquid crystal display device, the ability to manufacture defect-free TFTs and elements of the display element in each pixel and circuit line pattern of lines for supplying power and data to the TFT and display element is desired to enable improvement in display quality and yield.

In actual practice, however, because of increases in the resolution and size of display devices, the number of pixels and the degree of integration have increased such that total prevention of the occurrence of defects in the TFT or in the line remains impossible. If all of substrates (panels) in which a defect occurs in the element formed on one panel or in the line pattern, such as a line, formed on one panel are discarded, the yield would be significantly reduced and the manufacturing cost would be significantly increased. Therefore, in common industrial practice, a repair process is applied to repair defects and obtain a usable product.

In the related art, defects in the active matrix liquid crystal display devices are found after almost all of the circuit elements to be formed on one substrate have been formed, by, for example, sequentially selecting each pixel and causing that pixel to display.

However, because a pixel includes at least one TFT, a storage capacitor for storing data, and a pixel electrode, it is often not possible to identify a cause of a detect by merely observing a display in the display element which is ultimately driven and/or a potential of the pixel electrode. In addition, there may be cases in which other circuits are formed over the defect region making repair physically impossible.

In consideration of the above, a method of manufacturing an active matrix liquid crystal display device can be conceived in which, before each pixel is completed, more specifically, when manufacturing of a TFT substrate is completed to a state before two substrates are affixed with liquid crystal therebetween to form the LCD, defects such as disconnections and short-circuiting in the TFT formed on the TFT substrate, a scan line for driving and controlling the TFT (gate line), and a data line are examined and repaired. Such examination and repairing of defects of the TFT substrate are performed after at least the line layer at the topmost layer of the TFT is covered by an insulating film, in consideration of protection of the circuit element from static electricity or the like.

As mentioned for repairing a disconnection on the TFT substrate, a method called CVD (chemical vapor deposition) repair may be employed. The CVD repair method is a method applied when a line which should be connected is disconnected as shown in FIG. 1A, and connects the disconnected portion by selectively depositing, through CVD, a pattern of a conductive material for repair on the insulating film covering the line. More specifically, as shown in FIG. 1B, a laser is used to form contact holes penetrating through the interlayer insulating layer at a location upstream of the disconnected portion of the line (deficient defect portion) covered by the insulating layer to expose the lines at the bottom of the contact hole. Then, as shown in FIG. 1C, a desired arbitrary repairing line pattern r1 is drawn by scanning the portion between the contact holes, that is, the disconnected portion, with a laser beam within a material gas MG.

When CVD repair is employed, it is possible to reliably connect the disconnected portion with a high degree of freedom with respect to the TFT substrate. However, because a repairing material which differs from the conductive material forming the line is used to form the repair pattern, a large resistance component is formed at the connection portion. In addition, because contact holes are formed through the insulating film covering the line and a pattern of a material for repair is formed on the insulating film, the line length is elongated by at least twice the thickness of the insulating film, compared to a line without a disconnection, and thus, the line resistance is correspondingly increased.

Moreover, because the repairing of the disconnection is performed through connection of only the disconnected portion with the pattern of the repairing material, and by forming contact holes through the insulating film covering the line and forming the pattern of repairing material, a large local unevenness is created in the repaired portion compared to the line portion in which there is no disconnection.

### SUMMARY OF THE INVENTION

An advantage of the present invention is the disconnection which is a deficient defect can be reliably repaired while the increase in line resistance is inhibited.

According to one aspect of the present invention, there is provided a display device comprising, a plurality of pixels each having a display element and a plurality of line patterns for supplying power from a same power supply to the plurality of pixels, wherein, in a deficient defect portion of the line pattern, ends of the deficiency are connected to each other with a pattern of a conductive material for repair directly covering the ends, and an insulating film is formed covering the plurality of line patterns and the pattern of conductive material for repair.

According to another aspect of the present invention, it is preferable that, in the display device, the display element is formed above the insulating film.

According to another aspect of the present invention, it is preferable that, in the display device, the pattern of conductive material for repair is covered with a protection film formed by deposition subsequent to formation, by deposition, of the pattern of conductive material for repair.

According to another aspect of the present invention, it is preferable that, in the display device, the display element is an organic electroluminescence element having an organic layer.

According to another aspect of the present invention, it is preferable that, in the display device, ends of the deficiency and a line pattern adjacent to the line pattern in which the deficient defect occurs are connected to each other with the pattern of conductive material for repair.

According to another aspect of the present invention, there is provided a display device comprising, a plurality of pixels each having a display element and a plurality of line patterns for supplying power from a same power supply to the plurality of pixels, wherein each of the plurality or pixels further comprises a transistor for operating the display element, the transistor is formed between a lower electrode of the display element and a substrate, each of the plurality of line patterns is a current supply line pattern connected to a corresponding one of the transistors for supplying current to the display element through the transistor, ends of deficiency are connected to each other, in a deficient defect portion of the line pattern, with a pattern of conductive material for repair directly covering the ends, an insulating film is formed covering the plurality of line patterns and the pattern of conductive material for repair, and the lower electrode of the display element is formed above the insulating film.

According to the present invention, it is possible to form a pattern of conductive material for repair (repair line) with respect to a disconnection (deficient defect) occurring in a thin film transistor or a line for the thin film transistor formed in an active matrix display device or other semiconductor devices, with a low line resistance and while maintaining flatness of upper layers.

### BRIEF DESCRIPTION OF THE DRAWINGS

Preferred embodiments of the present invention will be described in detail based on the following figures, wherein:

FIGS. 1A, 1B and 1C are diagrams showing a method of CVD repair for a disconnected portion;

FIG. 2 is a diagram schematically showing a circuit structure of an organic electroluminescence display device according to a first preferred embodiment and a second preferred embodiment of the present invention;

FIG. 3 is a partial cross sectional view of a pixel in an organic electroluminescence display device according to a first preferred embodiment of the present invention;

FIGS. 4A and 4B are diagrams showing an example of a disconnection and a repair pattern of the disconnection according to a first preferred embodiment of the present invention;

FIGS. 5A and 5B are diagrams showing another example of a disconnection and a repair pattern of the disconnection according to a first preferred embodiment of the present invention;

FIGS. 6A and 6B are diagrams showing another example of a disconnection and a repair pattern of the disconnection according to a first preferred embodiment of the present invention;

FIGS. 7A, 7B, 7C, 7D and 7E are diagrams for explaining a repair process of disconnection according to a first preferred embodiment of the present invention;

FIG. 8 is a diagram showing another example of a partial cross section of a pixel in an organic electroluminescence display device according to a first preferred embodiment of the present invention;

FIG. 9 is a diagram showing another example of a partial cross section of a pixel in an organic electroluminescence display device according to a second preferred embodiment of the present invention; and

FIGS. 10A, 10B and 10C are diagrams for explaining a repair process of disconnection according to a second preferred embodiment of the present invention.

### DESCRIPTION OF PREFERRED EMBODIMENTS

Preferred embodiments of the present invention (hereinafter referred to simply as “embodiments”) will now be described referring to the drawings.

A display device according to a first preferred embodiment of the present invention is applied to an active matrix display device having a display element and a TFT for driving the display element in each pixel and will be hereinafter described exemplifying an active matrix electroluminescence (hereinafter simply referred to as “EL”) element which uses an EL element as the display element and has an organic EL element and a TFT for controlling and driving the organic EL element in each pixel.

Among various active matrix display devices, because an active matrix display device which uses an EL element, in particular, an organic EL element having an organic material as a light emitting material is self-emissive and requires no light source, a display device having a thinner thickness than an LCD or the like can be realized with an EL display device, and, thus, much research is dedicated to developing and improving active matrix organic EL display devices.

The organic EL element is a current-driven display element in which light is emitted corresponding to a current flowing between an anode and a cathode formed sandwiching an organic layer containing a light emitting organic material. Therefore, in an organic EL display device, a current supply line for supplying current to the organic EL element provided in each pixel is required and an amount of current flowing through the current supply line is significantly larger than, for example, the amount of current supplied to each pixel in a voltage-driven liquid crystal display device in which liquid crystal is AC driven. Because the amount of current flowing through the line is relatively large, a large voltage drop occurs even with a slight increase in the line resistance, resulting in a significant variation in light emission brightness of the organic EL elements among pixels. Therefore, it is important to minimize the resistance at a location where a disconnection is repaired.

In an organic EL display device, a very thin organic layer containing a light emitting organic material is formed between an anode and a cathode. Because the layer is so thin, and because significant unsolved durability problems remain, it is strongly desired that the formation surface of the organic layer be flat and smooth to the highest possible degree.

In an active matrix organic EL display device, it is preferable that the TFT and lines be formed before the organic EL element is formed (that is, the TFT and lines are formed below the organic EL element), because there is a problem in that the organic EL element has a low durability to semiconductor processes. Thus, regarding repairing of defects of the TFT and lines, by executing the repair process before the organic EL element is formed so that the lines and electrode to be formed in the upper layers do no block the repairing process, it is possible to realize an easy and reliable repairing. In consideration of this, in the present embodiment, a defect examination process and a defect repairing process are executed after the TFT and lines are formed over a substrate and before the organic EL element is formed, to improve the yield of the products. In this process, however, because an organic EL element will be formed after the defect repairing, it is necessary to minimize unevenness in the portion in which the defect is repaired to achieve a flat formation surface for the organic EL element above the repaired portion.

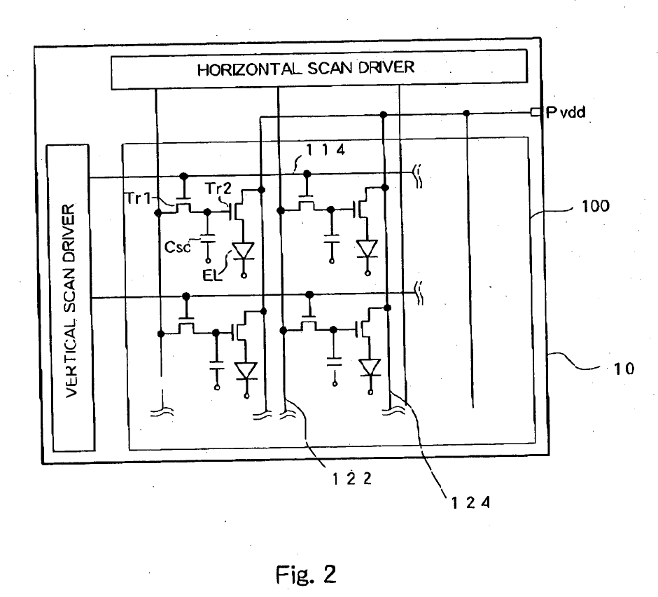

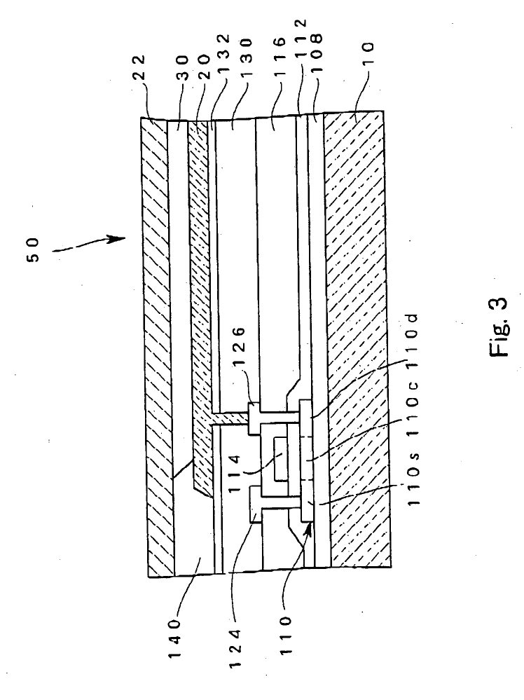

FIG. 2 schematically shows a circuit structure of an active matrix organic display device according to the present embodiment. FIG. 3 schematically shows a cross sectional structure of a second thin film transistor Tr2 connected to a power supply line 124 and an organic EL element 50 connected to the second thin film transistor Tr2 in a pixel of the active matrix organic EL display device shown in FIG. 2. A display section 100 in which a plurality of pixels are arranged in a matrix form is formed on a transparent substrate 10 such as glass, and each pixel comprises an organic EL element (EL) 50, a switching element for controlling light emission in the organic EL element 50 in each pixel (in this embodiment, a thin film transistor (TFT)), and a storage capacitor Csc for storing display data.

In the example configuration of FIG. 2, a first thin film transistor Tr1 and a second thin film transistor Tr2 are formed for each pixel. The first thin film transistor Tr1 is connected to a scan line (gate line) 114 and, when the first thin film transistor Tr1 is switched on with application of a scan signal, a voltage signal corresponding to display content and applied to a corresponding data line 122 is applied to a gate of the second thin film transistor Tr2 through the first thin film transistor Tr1. In addition, the voltage signal is also supplied to the storage capacitor Csc connected between the first and second thin film transistors Tr1 and Tr2 so that the storage capacitor Csc stores the voltage signal for a predetermined period. The second thin film transistor Tr2 supplies a current corresponding to a voltage stored in the storage capacitor Csc and applied to the gate of the second thin film transistor Tr2, from a supply line 124 of power supply (Pvdd) (hereinafter referred to as “power supply line”) to an anode (a hole injection electrode) 20 of the organic EL element connected to the second thin film transistor Tr2. The organic EL element 50 emits light with a luminance corresponding to an amount of supplied current and the emitted light is transmitted to the outside through a transparent first electrode (the anode) 20 made of ITO or the like and the transparent substrate 10.

The organic EL element 50 has a light emitting element layer 30 between a first electrode 20 and a second electrode 22. The first electrode 20 is made of a transparent conductive material such as ITO (Indium Tin Oxide) and IZO (Indium Zinc Oxide) and, in this embodiment, has a hole injection function. The light emitting element layer 30 formed over the first electrode 20 has a single-layer structure or a multi-layer structure having at least an organic light emitting compound. The second electrode 22 which is formed above the light emitting element layer 30 to oppose the first electrode 20 has a layered structure of, for example, a metal such as Al and an alloy of Al and a material which reduces an electron injection barrier for this metal such as LiF, and has an electron injection function.

Although not shown in FIG. 3, the first thin film transistor Tr1 has a structure similar to that of the second thin film transistor Tr2 which is shown. In the embodiment, polycrystalline silicon polycrystallized by annealing amorphous silicon with laser is used in the active layer 110 of the first and second thin film transistors Tr1 and Tr2. In the present embodiment, the first and second thin film transistors Tr1 and Tr2 are top-gate type TFTs in which a gate electrode 114 is provided above a gate insulating layer 112 formed covering the active layer 110. A channel region 110c is formed in a region of the active layer 110 below the gate electrode 114 and, on both sides of the channel region 110c, a source region 110s and a drain region 110d to which impurities are predetermined conductive type are doped are formed. Alternatively, the first and second thin film transistors Tr1 and Tr2 may be bottom-gate type TFTs in which the gate electrode 114 is formed below the active layer 110. In addition, in the present embodiment, the gate insulating layer 112 has a layered structure in which SiO₂ and SiN are layered in this order from the side near the active layer 110. A buffer layer 108 having a multi-layer structure of SiO₂ and SiN formed in this order from the side in contact with the active layer 110 is formed between the active layer 110 and the substrate 10 for preventing entrance of impurities such as Na from the substrate 10 to the active layer 110.

An interlayer insulating layer 116 having a multi-layer structure in which, for example SiN and SiO₂ are layered in this order from the lower layer is formed over almost the entire surface of the substrate covering the gate electrode 114. The power supply line 124 is connected to one of the source 110s and the drain region 110d through a contact hole formed through the interlayer insulating layer 116 and a contact electrode 126 is connected to the other one of the source region 110s and the drain region 110d. A first planarizing insulating layer 130 made of, for example, an organic material such as resin (may alternatively be an inorganic material) is formed to almost entirely cover the substrate including the lines 124 and 126. The first electrode 20 of the organic EL element 50 is layered above the first planarizing insulating layer 130 and a second planarizing insulating layer 140 is layered covering the ends of the first electrode 20. The first electrode 20 is connected to the contact electrode 126 via a contact hole through the first planarizing insulating layer 130. Above the first electrode 20, the light emitting element layer 30 and the second electrode 22 are formed in this order.

In addition to the above-described structure, in the present embodiment, a protection film 132 covering a line pattern for repairing a defect which will be described later is formed between the first planarizing insulating layer 130 and the first electrode 20. An organic EL panel used in a display device is completed by adhering a sealing substrate to the transparent substrate 10 from the side of the second electrode in an inert gas atmosphere after the circuit elements as described are formed on the transparent substrate 10. Regarding examination of the organic EL panel, after the organic EL element which is the uppermost layer is formed, it is only possible to observe the light emitting condition of the organic EL panel. Even when there is an abnormality in light emission, it is not possible to ascertain whether the abnormality is caused by disconnection or short-circuiting in the TFTs (Tr1, Tr2, etc.) for driving the organic EL element or in the lines. Therefore, as described, even with a multi layered line structure as described, in order to repair the defects with knowledge of the defects and of whether a particular defect is caused by the TFTs or lines, in addition to the viewpoint of problem of durability of the organic EL element 50, the TFTs and lines are examined at a timing which is after the TFT is formed over the substrate, the lines for supplying data signals and current to these TFTs (data line 120 and power supply line 214) are formed, and before the first electrode 20 of the organic EL element 50 is formed. When a defect is found, the defect is repaired.

As another example configuration, it is possible to examine for defects within a pixel after formation of the first electrode made of a transparent conductive material such as ITO is completed, through an examination method using the ITO. Then, the detected defective portion is repaired. When the defect is an open defect (disconnection), a line is formed (connected) by laser CVD and when the defect is a short-circuiting defect (short circuiting), the short-circuit is cut by a laser, to repair the defect.

In this process, because an unevenness is created in the insulating film between the electrode line and the pixel electrode, a layer targeted for planarization is formed after the repairing step of the defect to complete the structure. As this layer, it is possible to use the second planarizing insulating layer 140 or an insulating film projecting from the second planarizing insulating layer 140 for supporting a deposition mask used in the deposition of an organic EL material. When these layers cannot be used, it is also possible to separately provide a film with a flat surface.

A method of repairing a defect in the present embodiment (in this description, a deficient defect (disconnection)) will be described referring to an example case of occurrence of disconnection in a power supply line 124 for supplying current to the organic EL element through the second thin film transistor Tr2. For repairing short-circuiting defects, a process such as ablation to cut the short-circuit portion with laser or the like is applied.

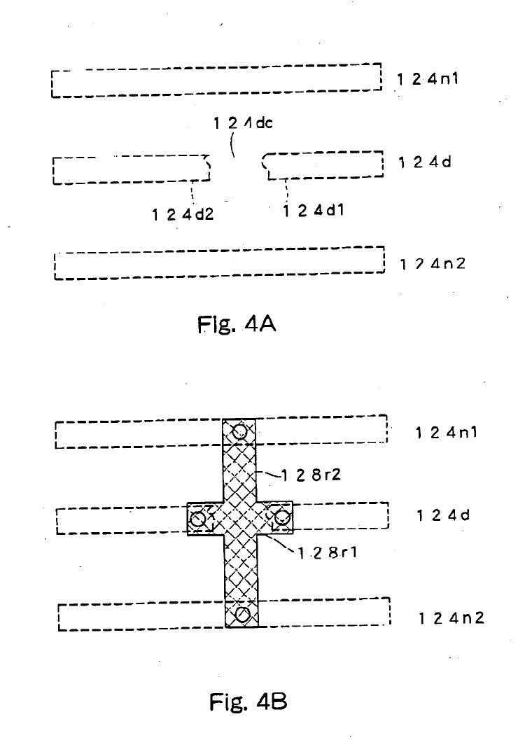

In a first example case of the present embodiment, after the data line 122, the power supply line 124, and the contact electrode 126 are formed over the interlayer insulating layer 116 and the first planarizing insulating layer 130 is formed covering these layers, an examination process of defects is executed. As shown in FIG. 2, the power supply lines 124 arranged in a stripe pattern along a column direction in the display section 100 on the substrate are connected to each other around the periphery of the display section 100 and are connected to a common power supply terminal Pvdd. When a disconnection occurs in the power supply line 124 as shown in FIG. 4A, in the present embodiment, not only the disconnected portion 124dc is connected, but also, a grid-shaped (cross shaped) pattern is formed which is connected to power supply lines 124n1 and 124n2 adjacent to the power supply line 124d in which disconnection occurs, as shown in FIG. 4B.

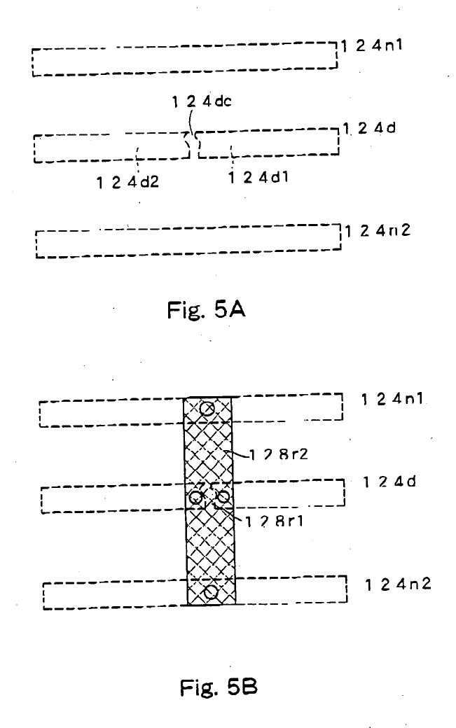

As shown in FIG. 5A, when the distance of disconnection of the power supply 124 is short, a repair line 128 may be of a rectangular pattern having a width which is sufficient to cover the disconnected portion 124dc and connected the disconnected portion 124dc and the adjacent power supply lines 124n1 and 124n2, instead of a grid pattern as shown in FIG. 4B. Alternatively, it is also possible to employ a grid pattern in such a case.

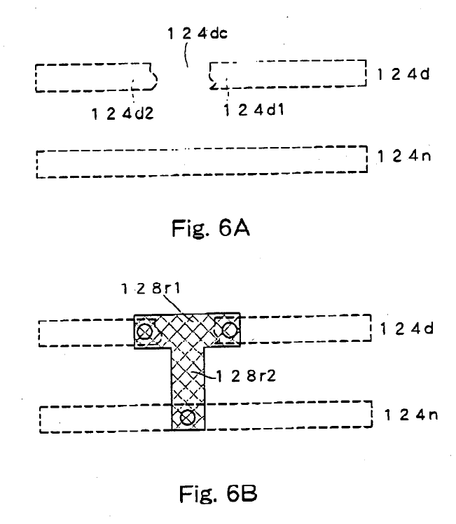

When there is only one adjacent power supply line 124n, on one side of the disconnected supply line 124d, which is adjacent to the disconnected power supply line 124d as shown in FIG. 6A, it is possible to employ a T-shaped pattern (or reverse T-shaped pattern) in which the disconnected portion 124dc is connected (128r1) and the adjacent power supply line 124n adjacent to the disconnected portion 124dc is connected to the disconnected portion 124dc as shown in FIG. 6B or a rectangular pattern as shown in FIG. 5B. When the line resistance can be maintained at a sufficient low value, it is possible to employ a T-shaped pattern or a rectangular pattern instead of the cross-shaped pattern.

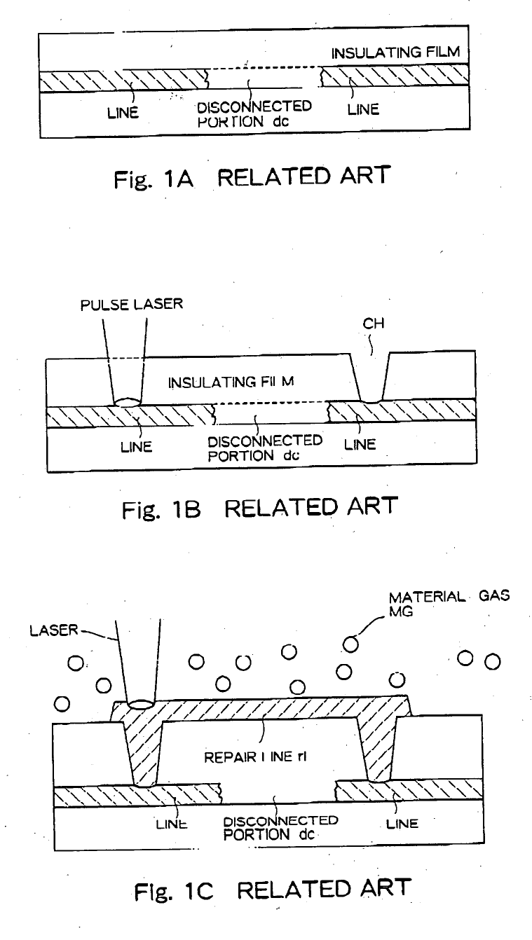

When only the disconnected portion is repaired by drawing a repair pattern through CVD as described above and shown in FIG. 1, unevenness by the deposition pattern significantly influences the flatness of the layers above the repaired portion. In the present embodiment, on the other hand, as shown in FIGS. 4B, 5B, and 6B, a pattern is formed connecting the disconnected portion and the adjacent line or lines of the disconnected line. With such as configuration, it is possible to reduce local unevenness. In addition, because the area of the repair line can be substantially increased, the resistance of the repair pattern can be reduced.

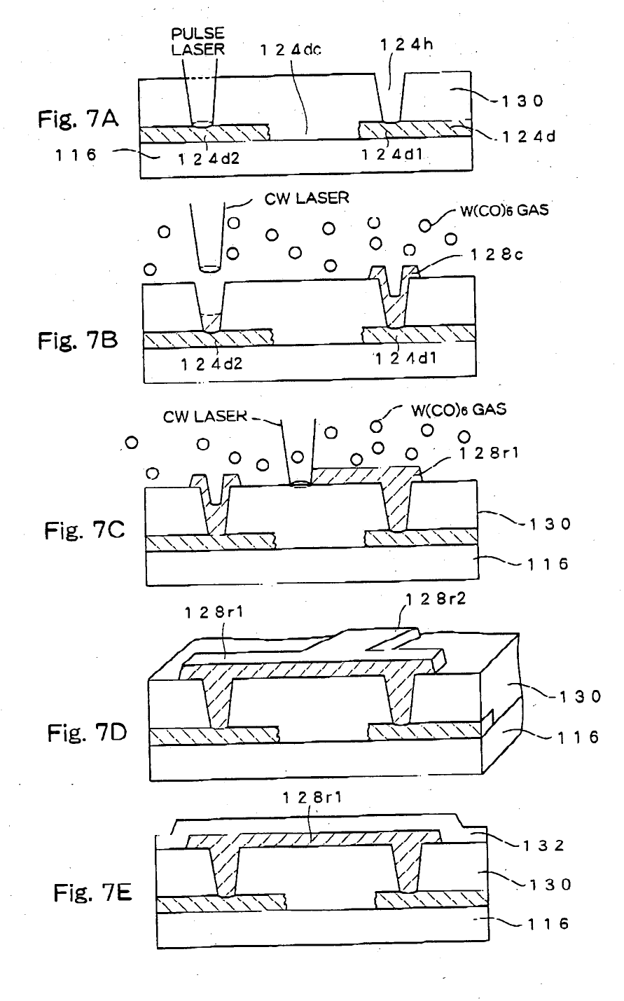

FIG. 7 shows a repair procedure of a disconnected portion of the power supply line 124 according to the present embodiment. The procedure will now be described referring to FIG. 7 and also to FIGS. 3-6. After necessary TFTs are formed on the substrate 10 and the first planarizing insulating film 130 is formed covering the TFTs, the structure is examined for defects. When a disconnection as shown in FIG. 7A is found, a pulse laser is irradiated from above the first planarizing insulating film 130 toward ends 124d1 and 124d2 of the line in contact with the disconnected portion 124dc of the power supply line 124d in which disconnection is found, to remove the first planarizing insulating film 130 to form contact holes 124h to expose a surface of the line ends 124d1 and 124d2. As shown in FIG. 4B, a pulse laser is irradiated from above the first planarizing insulating film 130 to position on the adjacent power supply lines 124n1 and 124n2 closest to the disconnection portion 124dc, the adjacent power supply lines being places on both sides (or one side) of the disconnected power supply line 124d, to remove the first planarizing insulating film 130 to form contact holes 124h, to expose a surface of the adjacent power supply lines 124n1 and 124n2.

In the present embodiment, a gas of tungsten carbonyl complex (W(CO)₆) is then used as a material gas for the repair line. As shown in FIG. 7B, a CW (continuous wave) laser is irradiated to the formation region of the contact holes 124h in the (W(CO)₆) atmosphere to form a tungsten film 128c for contact in the contact hole 124h. Then, as shown in FIG. 7C, the CW laser beam is scanned such that the disconnection ends 124d1 and 124d2 are connected with a minimum distance (typically, a straight line) as much as possible to draw and form a pattern of the repair line 128r1 on the first planarizing insulating film 130. Subsequent to formation of the repair line 128r1, the CW laser is scanned in the W(CO)₆ gas atmosphere to draw and form a repair line 128r2 crossing and connected to the repair line 128r1 and connecting the adjacent supply lines 124n1 and 124n2 and the 128r1 with a minimum distance (typically, a straight line). The repair lines 128r1 and 128r2 are preferably formed with a low line resistance by forming straight line connecting the two points to be connected with a minimum distance. However, in other circumstances such as, for example, when the repair line must detour around a line of a different potential, it is possible to form a curved pattern or a pattern of bent lines.

In order to improve the flatness of the upper surface of the repair lines 128r1 and 128r2, it is desirable to connect the repair line 128r1 and the adjacent power supply lines 124n1 and 124n2 on both sides with the repair line 128r2, such that the repair line 128r2 does not cross over the repair line 128r1 connecting between the disconnection ends 124d1 and 124d2 as shown in FIG. 7D. Scanning with the CW laser in the atmosphere of the material gas of the repair line can be executed by moving the substrate mounted on a substrate holder provided on a stage table in the X direction and in the Y direction along with the stage table. It is possible to employ a method including, for example, steps of moving the substrate so that the repair line 128r2 is drawn and formed from one of the adjacent power supply lines 124n1 and 124n2 toward the other one of the adjacent power supply lines 124n1 and 124n2, determining that the CW laser has crossed the repair line 128r1 with an optical sensor or the like, temporarily stopping irradiation of the CW laser and continuing to move the substrate, and restarting irradiation of CW laser after the repair line 128r1 is passed to continue drawing the repair line 128r2.

In the present embodiment, after the structure is scanned with a laser beam in an atmosphere including a material gas of conductive material for repair containing tungsten to thereby form a repair line 128 on the trace of the scan, a protection film 132 is formed covering the repair line 128 as shown in FIG. 7E. By forming the organic EL element 50 or the like as shown in FIG. 3 on the protection film 32 after the protection film 132 is formed covering the repair line 128, it is possible to reliably protect the repair line 128 from the resist abrasion liquid or the like during the formation of the organic EL element 50, in particular, during a photolithography step for forming the lower electrode 20 of the element into individual electrode for each pixel. In particular, the repair line 128 of tungsten as described above is easily transformed by acid or basic (alkaline) solution and is easily etched and removed by the resist stripper liquid and development agent, and thus must be covered by the protection film 132. In addition, as it is not desirable to form the first electrode 20 of the organic EL element 50 directly above the repair line 128, it is necessary to insulate the repair line 128 and the first electrode 20 with the protection film 132.

As the protection film 132, an insulating material may be used, and, for example, it is possible to use an insulating film containing silicon such as SiNx and SiO₂. The tormation method of the protection film 132 is not limited, and the protection film 132 may be formed, for example, through chemical vapor deposition (CVD), without damage to the repair line 128 below the protection film 132. According to the structure of the present embodiment, when the protection film 132 is formed using SiNx, in addition to the insulation of the repair line 128 and the first electrode 20 as described above, the protection film 132 can also function as a moisture block layer for preventing entrance of moisture from the side of the first planarizing insulating film 130 to the organic EL element 50. Degradation of the organic layer of an organic EL element 50 due to moisture or the like is a big problem in the organic EL element 50. By providing the protection film 132 between the first planarizing insulating film 130 and the element 50, it is possible to block entrance of moisture, for example, from the first planarizing insulating film 30 when an organic resin having a moisture absorbing characteristic is used in the first planarizing insulating film 130 and from the layers below the first planarizing insulating film 130, and, thus, such a configuration can significantly contribute to improvement in reliability and life span of the element 50. When the disconnection repairing method of the present embodiment is to be used in a configuration in which a moisture block layer is formed between the first planarizing insulating film 130 and the element 50 for preventing entrance of moisture, it is possible to obtain the protection film 132, without adding a separate step of forming the protection film 132, by allowing the moisture block layer to also function as the protection film 132.

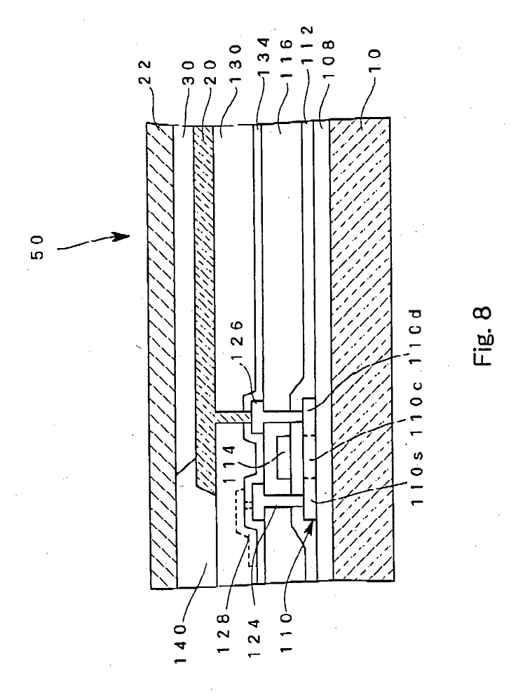

A second example configuration of the present embodiment will now be described. In this example configuration, as shown in FIG. 8, an insulating film 132 made of, for example, SiO₂ and SiNx is formed covering the power supply line 124, the contact electrode 126, the data line 120 which is not shown, etc., before the first planarizing insulating film 130 is formed. A difference from the first example configuration described above is that the defect examination and defect repairing processes are applied, not after the formation of the first planarizing insulating film 130, but after formation of the insulating film 134. As described, it is desirable to prevent entrance of moisture from the side of the substrate onto which the TFTs are formed to the organic EL element 50 having a low endurance to moisture. By forming an insulating film made of SiNx having a high moisture blocking capability below the first planarizing insulating film 130 as shown in FIG. 8, it is possible to prevent entrance of moisture to the organic EL element 50. Also, in general, impurities from the side of the substrate such as alkali ions also adversely affect the organic EL element 50. With the structure of the present embodiment, it is possible to also prevent entrance of these impurities. Similarly, it is also possible to prevent entrance of moisture and impurities from the organic EL element 50 to the TFTs.

In the second example configuration of the present embodiment, after the insulating film 134 is formed, the structure is irradiated with laser from above the insulating film 134 to expose a surface of ends 124d1 and 124d2 of the power supply line 124 in contact with the disconnected portion and of the adjacent lines 124n1 and 124n2. The structure is then scanned with the CW laser in an atmosphere of gas for line repairing, W(CO)₆, to form repair lines 128 (128r1 and 128r2). The repair line pattern is formed in a pattern connecting not only the disconnected portion but also to the adjacent power supply lines 124n1 and 124n2. These procedures are identical to those shown in FIGS. 7A-7D. In the second example configuration, however, the first planarizing insulating film 130 is formed over the repair line 128 and the organic EL element 50 is formed over the first planarizing insulating film 130. Therefore, the unevenness due to the presence of the repair line 128 can be more reliably planarized with the first planarizing insulating film 130 and thus, the formation surface of the organic EL element 50 can be planarized to a higher degree.

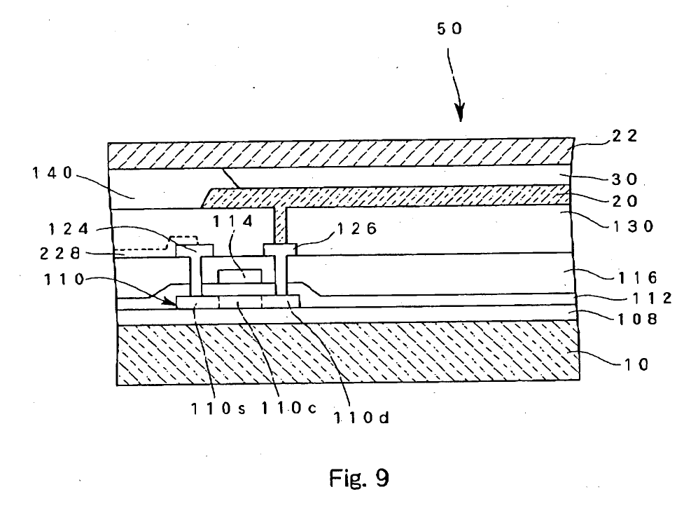

A second preferred embodiment of the present invention will now be described. In the first preferred embodiment described above, disconnection is repaired after the first planarizing insulating film 130 and the insulating film 134 are formed covering the power supply line 124. In the second preferred embodiment, on the other hand, the examination process for defects is applied immediately after the power supply line 124 is formed, a repair line 228 for repairing the disconnected portion is formed directly in contact with the power supply line 124 as shown in FIG. 9, and then, the first planarizing insulating film 130 is formed. By forming the first planarizing insulating film 130 after the repair line 228 is formed and a protection film such as the protection film 132 described above which is made of SINx or the like is formed, it is possible to reliably protect the repair line 228 from the resist abrasion liquid or the like used in the later steps, even when, for example, tungsten is used in the repair line 228.

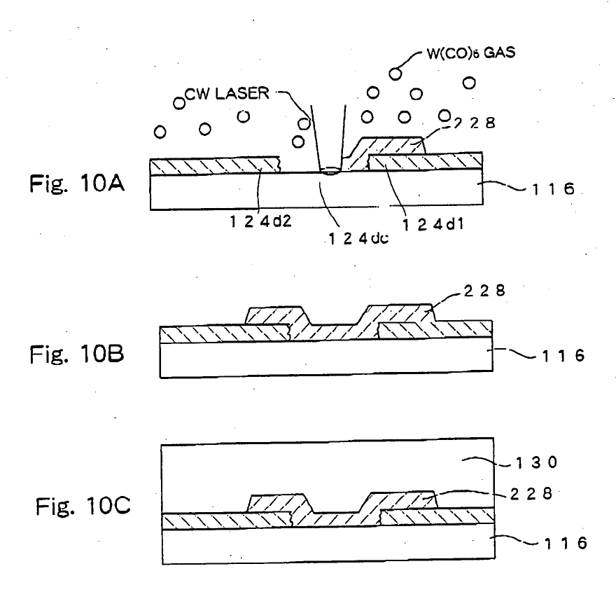

In the second preferred embodiment of the present invention, the laser irradiation process for removing the insulating films (130 and 134) in the first preferred embodiment is unnecessary. As shown in FIG. 10A, a repair line 228 is drawn and formed with a CW laser between ends 124d1 and 124d2 of the power supply line in contact with the found disconnected portion 124dc in an atmosphere of material gas of the repair line (W(CO)₆) to connect the ends 124d1 and 124d2 (FIG. 10B).

In addition, in the second preferred embodiment, the formation step of the first planarizing insulating film 130 is always applied after the repair line 228 is formed as shown in FIGS. 9 and 10C. Therefore, it is possible to almost entirely remove unevenness in the formation surface of the organic EL element 50 due to the presence of the repair line 228, and thus, it is possible to further improve flatness of the formation surface of the organic EL element 50 compared to the first example configuration of the first preferred embodiment. In addition, because the repair line 228 is formed directly on the power supply line 124 and not through a contact hole, unevenness due to the contact holes does not exist compared even to the second example configuration of the first preferred embodiment, and, thus, it is possible to improve the flatness of the formation surface of the organic EL element 50.

In the second preferred embodiment, because the repair line 228 is formed in the disconnected portion of the power supply line 124 immediately after the power supply line 124 is formed, it is not necessary to extend the repair line 228 over the insulating film through the contact hole as in the first preferred embodiment. Thus, the effective line length can be reduced and the line resistance can be reduced. In addition, because the contact hole is not necessary, it is possible to increase an area in which the power supply line 124 and the repair line 228 actually contact each other, and, consequently, reduce the resistance of the connection section of the power supply line 124 and the repair line 228. Because of this configuration, in the second preferred embodiment, it is not necessary to employ, in the repair line 228, a pattern having contacts with adjacent power supply lines 124 in addition to the contact for the disconnected portion, as in the first preferred embodiment. In addition, because it is possible to significantly reduce the influence of the presence of the repair line 228 on the flatness of the formation surface of the organic EL element 50, it is not necessary to connect the adjacent power supply line 124 also from this viewpoint. Therefore, it is possible to employ a pattern which connects only the disconnected portion 124dc and the formation time of the repair line 228 can be reduced compared to the first preferred embodiment, resulting in improvement of operation efficiency. Alternatively, it is also possible to employ the pattern of the first embodiment as shown in FIGS. 4B, 5B, and 6B when preferable for purposes such as reduction of the line resistance and further improvement of flatness of the upper layers.

In the first and second preferred embodiments, an organic EL element is exemplified as an element formed after the disconnection repair. The process, however, is not limited to an organic EL element and may be used, for example, in a disconnection repair of a power supply line for supply an AC power supply to each element in a display which uses an inorganic EL element, to allow repair with a small increase in the line resistance and a small voltage drop. In addition, the flatness at the upper layers of the repair line can be secured. However, as described above, flatness of the formation surface is strongly desired and variation in luminance due to a voltage drop is large in an organic EL element, and thus, advantages of the method are very high in employing a method for repairing disconnection as described in the preferred embodiments for an organic EL element. The method for repairing disconnection of the present invention can also be applied to a liquid crystal display device. In an active matrix liquid crystal display device a multi-layer line structure is used, the upper surface of the pixel electrode is preferably flat in order to reduce a disturbance in orientation among liquid crystal molecules, the liquid crystal must be precisely controlled with a low voltage, and improvement in the yield is desired. Because of these reasons, execution, before formation of the pixel electrode for driving the liquid crystal capacity formed between the pixel electrode and an electrode on an opposing substrate, of defect repair process of the TFTs and lines which are formed before the pixel electrode with a low line resistance and reduced degree of unevenness on the upper surface is highly advantageous.

1. A display device comprising:
a plurality of pixels each having a display element and a plurality of line patterns for supplying power from a same power supply to the plurality of pixels; wherein
in a deficient defect portion of the line pattern, ends of the deficiency are connected to each other with a pattern of a conductive material for repair directly covering the ends, and
an insulating film is formed covering the plurality of line patterns and the pattern of conductive material for repair.

2. A display device according to claim 1, wherein
the display element is formed above the insulating film.

3. A display device according to claim 1, wherein
the pattern of conductive material for repair is covered with a protection film formed by deposition subsequent to formation, by deposition, of the pattern of conductive material for repair.

4. A display device according to claim 1, wherein
a material of the pattern of conductive material for repair contains tungsten.

5. A display device according to claim 4, wherein
the pattern of conductive material for repair is covered with a protection film formed by deposition subsequent to formation, by deposition, of the pattern of conductive material for repair.

6. A display device according to claim 1, wherein
the display element is an organic electroluminescence element having an organic layer.

7. A display device comprising:
a plurality of pixels each having a display element and a plurality of line patterns for supplying power from a same power supply to the plurality of pixels, wherein
in a deficient defect portion of the line pattern, ends of the deficiency are connected to each other with a pattern of a conductive material for repair directly covering the ends and the ends of deficiency and a line pattern adjacent to the line pattern in which the deficient defect occurs are connected to each other with the pattern of conductive material for repair, and
an insulating film is formed covering the plurality of line patterns and the pattern of conductive material for repair.

8. A display device comprising:
a plurality of pixels each having a display element and a plurality of line patterns for supplying power from a same power supply to the plurality of pixels, wherein
each of the plurality of pixels further comprises a transistor for operating the display element;
the transistor is formed between a lower electrode of the display element and a substrate;
each of the plurality of line patterns is a current supply line pattern connected to a corresponding one of the transistors for supplying current to the display element through the transistor;
ends of deficiency are connected to each other, in a deficient defect portion of the line pattern, with a pattern of conductive material for repair directly covering the ends;
an insulating film is formed covering the plurality of line patterns and the pattern of conductive material for repair; and
the lower electrode of the display element is formed above the insulating film.

9. A display device according to claim 8, wherein
the insulating film is a planarizing insulating film.

10. A display device according to claim 8, wherein
the display element is an organic electroluminescence element having an organic layer.

11. A display device according to claim 8, wherein
the lower electrode of the display element has a pattern individual to each pixel.
